(19) United States
(12) Patent Application Publication
(10) Pub. No.: US 2023/0349763 A1
(43) Pub. Date: Nov. 2, 2023

(54) RAMAN DETECTING CHIP, METHOD OF FABRICATING THE SAME AND RAMAN SPETROSCOPY DETECTING SYSTEM USING SUCH RAMAN DETECTING CHIP

(71) Applicant: National Tsing Hua University, Hsinchu (TW)

(72) Inventors: TaJen YEN, Zhubei City (TW); Wei-Cheng LIN, Taichung City (TW); Fang Jing LEE, Hsinchu City (TW)

(21) Appl. No.: 17/902,578

(22) Filed: Sep. 2, 2022

(30) Foreign Application Priority Data
Apr. 29, 2022 (TW) 111116350

(51) Int. Cl. G01J 3/44; G01N 21/65

(52) U.S. Cl. CPC G01J 3/4412; G01N 21/658

(57) ABSTRACT

A Raman detecting chip, a method of fabricating the same and a Raman spectroscopy detecting system using such Raman detecting chip are disclosed. The Raman detecting chip according to the invention includes a substrate, a plurality of nanowires and a plurality of three-dimensional dendritic metal nanostructures. The substrate has a recess. The recess has a circular opening and a circular bottom surface. The plurality of nanowires are formed on the circular bottom surface and protrude upwards. The plurality of three-dimensional dendritic metal nanostructures are formed on a plurality of tops of the plurality of nanowires and extend beyond the circular opening.

### CROSS-REFERENCE TO RELATED APPLICATION

This utility application claims priority to Taiwan Application Serial Number 111116350, filed Apr. 29, 2022, which is incorporated herein by reference.

### BACKGROUND OF THE INVENTION

### 1. Field of the Invention

The invention relates to a Raman detecting chip, a method of fabricating the same and a Raman spectroscopy detecting system using such Raman detecting chip, and more in particular, to a Raman detecting chip including metal nanostructures with high localized surface plasmon resonance, a method, with short process time and low process cost, of fabricating the same and a Raman spectroscopy detecting system using such Raman detecting chip and having with semi-quantitative detection capability.

### 2. Description of the Prior Art

So far, traditional detection techniques include chromatography, mass spectrometry, immunoprotein assays, etc. However, most of the mentioned above methods are quite expensive and complicated in process, require a long analysis time, and are often designed for a single specific analyte. There is still a long way to go before the fast-screen application. It is well known that Raman spectroscopy is a powerful analytical technique and can provide information according to molecular structure. Therefore, Raman spectrum is also called the fingerprint of molecular. Raman spectrum has been widely used in biosensing, medical and pharmaceutical, environmental monitoring, forensic science, health monitoring and other fields in recent years due to its fingerprint specificity and multi-domain application characteristics. However, due to the inherent weakness of the Raman signal for qualitative identification and quantitative analysis, the collected signal is very weak when the Raman spectroscopy is used to detect trace substances, which will cause difficulties in detection, be easily interfered by a large number of complex samples and thus reduce the detection sensitivity.

In the prior arts, gold nanoparticles are formed on Raman detecting chips to generate localized surface plasmon resonance (LSPR), and thereby the Raman detecting chips can achieve the effect of surface-enhanced Raman spectroscopy. Most of the prior arts use reactive-ion etching (RIE) technology to bombard the target silicon substrate with reactive ion gas, so as to etch silicon nanowires with a large surface area on the silicon substrate. Then, most of the prior arts form gold nanoparticles coated on silicon nanowires by oblique angle deposition (OAD).

However, using an electron beam evaporation system to coat gold nanoparticles on silicon nanowires can accurately control the parameters of metal deposition, but it requires a high vacuum environment, requires a long process time, and has high process costs.

In addition, there is still room for improvement in the localized surface plasmon resonance generated by the metal nanostructures on the Raman detecting chips of the prior arts. In the Raman detecting chips of the prior arts, the signal intensity of Raman spectrum characteristic values obtained from different detected positions on the Raman detecting chip is greatly different, that is, the detected signal intensity is unstable.

In addition, the Raman detecting chip of the prior art is difficult to measure the solution of the volatile substance to be detected. Because the solute in the solution of the analyte will produce a coffee ring effect due to the rapid evaporation rate of the solvent, the problem of uneven concentration of the analyte on the Raman detecting chip of the prior art is caused. The so-called coffee ring effect is due to the evaporation of the solvent in the solution, which causes the solute to diffuse outward, resulting in uneven concentration of the analyte. This phenomenon of uneven concentration of the analyte will lead to uneven distribution of the signal intensity of the Raman spectrum characteristic values. Overcoming the coffee ring effect can make Raman spectroscopy technology easier to apply to semi-quantitative detection.

### SUMMARY OF THE INVENTION

Accordingly, one scope of the invention is to provide a Raman detecting chip including metal nanostructures with high localized surface plasmon resonance, a method, with short process time and low process cost, of fabricating the same and a Raman spectroscopy detecting system using such Raman detecting chip and having with semi-quantitative detection capability.

A Raman detecting chip according to a preferred embodiment of the invention includes a substrate, a plurality of nanowires and a plurality of three-dimensional dendritic metal nanostructures. The substrate is formed of a semiconductor material. The substrate has an upper surface and a recess formed on the upper surface. The recess has a circular opening and a circular bottom surface. The plurality of nanowires are formed of the semiconductor material. The plurality of nanowires are formed on the circular bottom surface of the recess and protruding upwards. The plurality of three-dimensional dendritic metal nanostructures are formed on a plurality of tops of the plurality of nanowires, and extend beyond the circular opening of the recess.

A method of fabricating a Raman detecting chip according to a preferred embodiment of the invention is, firstly, to prepare a substrate formed of a semiconductor material. Then, the method according to the preferred embodiment of the invention is to partially form a photoresist layer on an upper surface of the substrate such that a circular exposed area is formed on the upper surface of the substrate. Next, the method according to the preferred embodiment of the invention is by a metal-assisted chemical etching process, to etch downwards the substrate at the circular exposed area into a plurality of nanowires, where the substrate has a recess, the recess has a circular opening and a circular bottom surface, and the plurality of nanowires are formed on the circular bottom surface of the recess and protrude upwards. Finally, the method according to the preferred embodiment of the invention is by an electroless plating process, to form a plurality of three-dimensional dendritic metal nanostructures on a plurality of tops of the plurality of nanowires, where the plurality of three-dimensional dendritic metal nanostructures extend beyond the circular opening of the recess.

In one embodiment, a solution of an analyte is dropped on the Raman detection chip with a titer (V) to cover the whole of the plurality of three-dimensional dendritic metal nanostructures without overflow. A contact angle (θ) between the solution and the plurality of three-dimensional dendritic metal nanostructures is defined. A relationship between a radius (r) of the circular opening of the recess and the titer (V) is as the following formula: V=⅔πr³(1−cos θ), where the unit of the titer (V) is μL, and the unit of the radius (r) of the circular opening is mm.

In one embodiment, a cross-sectional width of each three-dimensional dendritic metal nanostructure ranges from 40 μm to 250 μm.

In one embodiment, a height of each nanowire ranges from 0.5 μm to 15 μm.

In one embodiment, the plurality of three-dimensional dendritic metal nanostructures can be formed of silver (Ag), gold (Au), aluminum (Al), copper (Cu), tin (Sn), titanium (Ti), barium (Ba), platinum (Pt), cobalt (Co) or a mixture therebetween.

A Raman spectroscopy detecting system according to a preferred embodiment of the invention includes a Raman detecting chip according to the invention, an emitting apparatus, a receiving apparatus and an analyzing apparatus. A solution of an analyte is dropped on the Raman detecting chip according to the invention with a titer (V) to cover the whole of the plurality of three-dimensional dendritic metal nanostructures without overflow. The emitting apparatus is for emitting an initial beam onto the plurality of three-dimensional dendritic metal nanostructures, where the plurality of three-dimensional dendritic metal nanostructures scatter the initial beam into a scattered beam. The receiving apparatus is for collecting the scattered beam to generate a first Raman characteristic peak intensity. The analyzing apparatus therein stores a relationship between a second Raman characteristic peak intensity and a first concentration relative to the analyte. The analyzing apparatus is electrically connected to the receiving apparatus, and is for determining a second concentration of the analyte in accordance with the first Raman characteristic peak intensity and the relationship.

Different from the prior arts, the plurality of three-dimensional dendritic metal nanostructures on the Raman detecting chip according to the invention have much higher localized surface plasmon resonance. The solution of the analyte does not generate the coffee ring effect on the Raman detection chip according to the invention. The signal intensities of the Raman spectrum characteristic peaks obtained at different detected positions are very similar. The method of fabricating the Raman detecting chip according to the invention has short process time and low process cost. The Raman spectroscopy detecting system using the Raman detecting chip according to the invention has semi-quantitative detection capability.

The advantage and spirit of the invention may be understood by the following recitations together with the appended drawings.

### BRIEF DESCRIPTION OF THE APPENDED DRAWINGS

FIG. 1 is a top view of a Raman detecting chip according to the preferred embodiment of the invention.

FIG. 2 is an appearance photograph of an example of the Raman detecting chip according to the preferred embodiment of the invention.

FIG. 3 is a cross-sectional view of the Raman detecting chip according to the invention in FIG. 1 along the line A-A.

FIG. 4 is a scanning electron microscope (SEM) photograph of a cross-section of an example of the Raman detecting chip according to the preferred embodiment of the invention.

FIG. 5 is an oblique view SEM photograph of a cross-section of an example of the Raman detecting chip according to the preferred embodiment of the invention.

FIG. 6 is an SEM photograph of the appearance of a plurality of three-dimensional dendritic metal nanostructures of an example of the Raman detecting chip according to the preferred embodiment of the invention.

FIGS. 7 through 10 illustratively show a method of fabricating the Raman detecting chip as shown in FIGS. 1 and 3 with cross-sectional schematic drawings.

FIG. 11 shows a Raman spectrum diagram of p53 tumor suppressor protein at concentrations of 200 nM to 6.25 nM by using the Raman detecting chip according to the invention for enhancing detection.

FIG. 12 shows a Raman spectrum diagram obtained by using the Raman detection chip according to the invention to enhance the detection of p53 tumor suppressor protein droplets with a concentration of 200 nM at 10 random positions in the detection area.

FIG. 13 shows a diagram of Raman characteristic peak intensities of 2500 Raman measurements of p53 tumor suppressor protein droplets with a concentration of 200 nM in a randomly selected 50 μm×50 μm of detection area by using the Raman detecting chip according to the invention to enhance the detection.

FIG. 14 shows a diagram of the Raman characteristic intensities at 1350 cm⁻¹ of troponin I detected by using nine unpatterned detecting chips which each is used to detect a centration of troponin I.

FIG. 15 shows a diagram of the Raman characteristic intensities at 1600 cm⁻¹ of troponin I detected by using nine unpatterned detecting chips which each is used to detect a centration of troponin I.

FIG. 16 shows a diagram of the Raman characteristic intensities at 1350 cm⁻¹ of troponin I detected by using nine detecting chips with circular openings of 0.7 cm in diameter according to the invention, which each is used to detect a centration of troponin I.

FIG. 17 shows a diagram of the Raman characteristic intensities at 1600 cm⁻¹ of troponin I detected by using nine detecting chip with a circular opening of 0.7 cm in diameter according to the invention, which each is used to detect a centration of troponin I.

FIG. 18 is a diagram showing the relationship between the signal intensity and the concentration detected by using the Raman detecting chip according to the invention to assist in the detection of p53 human tumor suppressor protein at different concentrations (6.25 nM˜200 nM).

FIG. 19 is a schematic diagram showing the architecture of a Raman spectroscopy detecting system according to a preferred embodiment of the invention.

### DETAILED DESCRIPTION OF THE INVENTION

Some preferred embodiments and practical applications of this present invention would be explained in the following paragraph, describing the characteristics, spirit, and advantages of the invention.

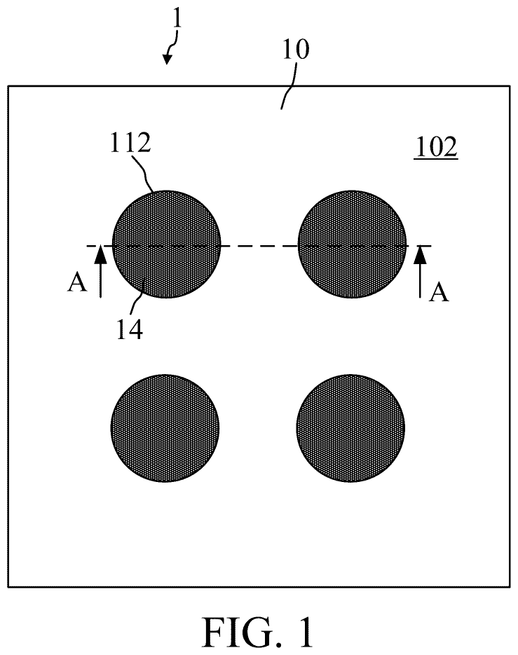

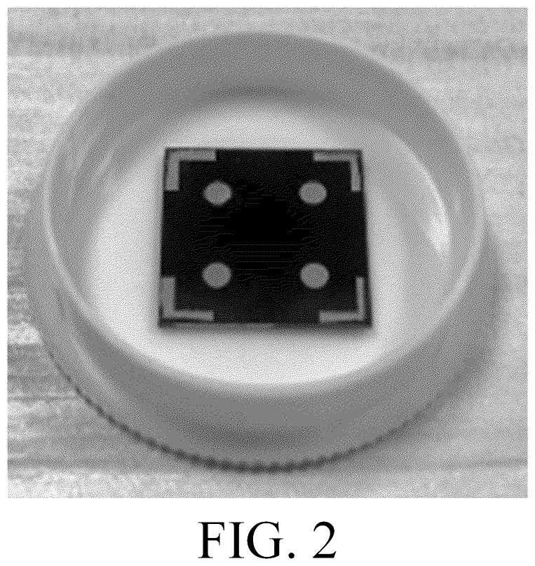

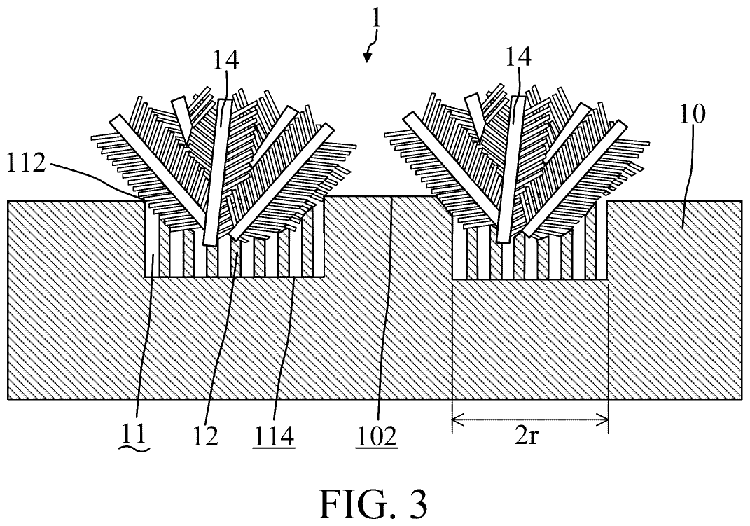

Referring to FIG. 1, FIG. 2 and FIG. 3, those figures schematically illustrate a Raman detecting chip 1 according to the preferred embodiment of the invention. FIG. 1 schematically shows the Raman detecting chip 1 according to the preferred embodiment of the invention with a top view. FIG. 2 is an appearance photograph of an example of the Raman detecting chip 1 according to the preferred embodiment of the invention. FIG. 3 is a cross-sectional view of the Raman detecting chip 1 according to the invention in FIG. 1 along the line A-A.

As shown in FIG. 1 and FIG. 3, the Raman detecting chip 1 according to a preferred embodiment of the invention includes a substrate 10, a plurality of nanowires 12 and a plurality of three-dimensional dendritic metal nanostructures 14. In FIG. 1, four Raman detecting chips 1 are illustrated as a representative.

Referring to FIG. 2, in the appearance photograph of the example of the Raman detecting chip 1 shown in FIG. 2, four Raman detecting chips 1 are simultaneously formed on the same substrate 10.

Also as shown in FIG. 1 and FIG. 3, the substrate 10 can be formed of a semiconductor material such as silicon, germanium, diamond, silicon germanium, silicon carbide, gallium arsenide, indium arsenide, indium phosphide, silicon germanium carbide, gallium arsenide phosphide, gallium indium phosphide, and the like. The substrate 10 can be formed from recycled wafers formed of the semiconductor materials mentioned above. The substrate 10 has an upper surface 102 and a recess 11 formed on the upper surface 102. The recess 11 has a circular opening 112 and a circular bottom surface 114.

The plurality of nanowires 12 are formed of the semiconductor material which is also used to form the substrate 10. The plurality of nanowires 12 are formed on the circular bottom surface 114 of the recess 11 and protruding upwards.

The plurality of three-dimensional dendritic metal nanostructures 14 are formed on a plurality of tops of the plurality of nanowires 12, and extend beyond the circular opening 112 of the recess 11. In FIG. 3, the reference symbol “2r” represents the diameter of the circular opening 112.

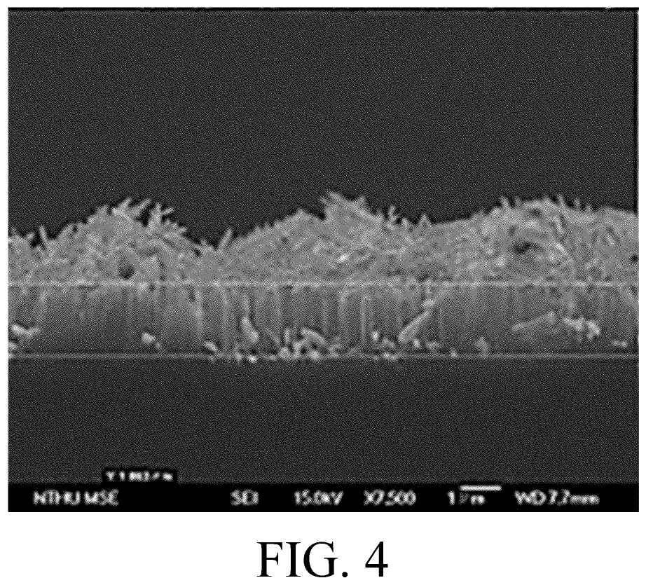

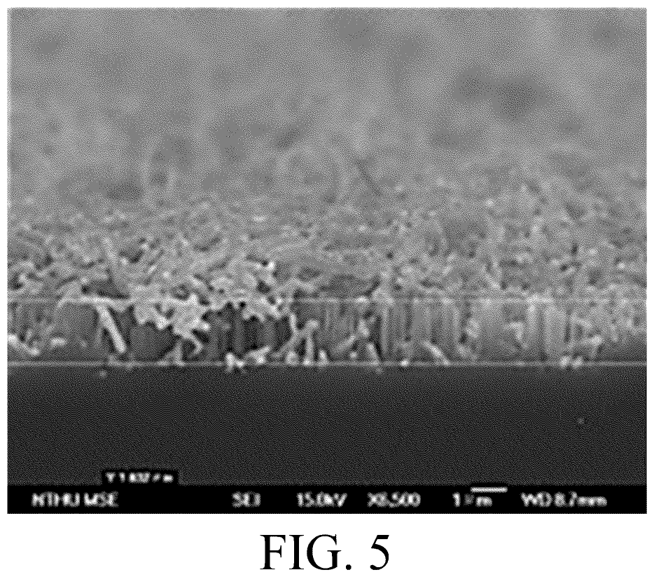

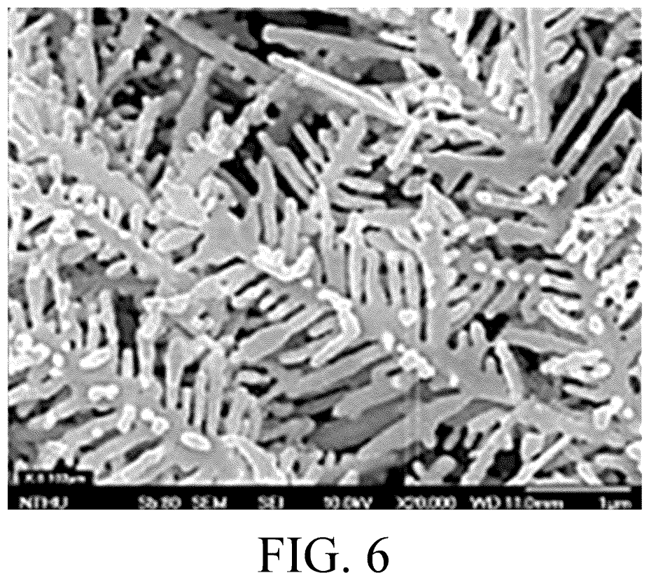

Referring FIG. 4, FIG. 5 and FIG. 6, those figures are SEM photographs taken from different viewing angles of an example of the Raman detecting chip 1 according to the preferred embodiment of the invention. FIG. 4 is an SEM photograph of a cross-section of the example of the Raman detecting chip 1 according to the preferred embodiment of the invention. FIG. 5 is an oblique view SEM photograph of a cross-section of the example of the Raman detecting chip 1 according to the preferred embodiment of the invention. FIG. 6 is an SEM photograph of the appearance of a plurality of three-dimensional dendritic metal nanostructures of the example of the Raman detecting chip 1 according to the preferred embodiment of the invention. In the SEM photographs shown in FIG. 4 and FIG. 5, it is shown that a plurality of nanowires 12 are formed on the circular bottom surface 114 of the recess 11 and extend upwards. A plurality of three-dimensional dendritic metal nanostructures 14 are formed on a plurality of tops of the plurality of nanowires 12.

In the SEM photograph shown in FIG. 6, each of the three-dimensional dendritic metal nanostructures 14 is branches extending from a main trunk and shorter branches extending from the branches.

Compared with the metal nanostructures on the Raman detecting chip of the prior art, the plurality of three-dimensional dendritic metal nanostructures 14 of the Raman detecting chip 1 according to the preferred embodiment of the invention have much higher localized surface plasmon resonance that can enhance the signal intensity of Raman characteristic peaks.

In one embodiment, a cross-sectional width of each three-dimensional dendritic metal nanostructure ranges from 40 μm to 250 μm.

In one embodiment, a height of each nanowire ranges from 0.5 μm to 15 μm.

In one embodiment, the plurality of three-dimensional dendritic metal nanostructures 14 can be formed of silver (Ag), gold (Au), aluminum (Al), copper (Cu), tin (Sn), titanium (Ti), barium (Ba), platinum (Pt), cobalt (Co) or a mixture therebetween.

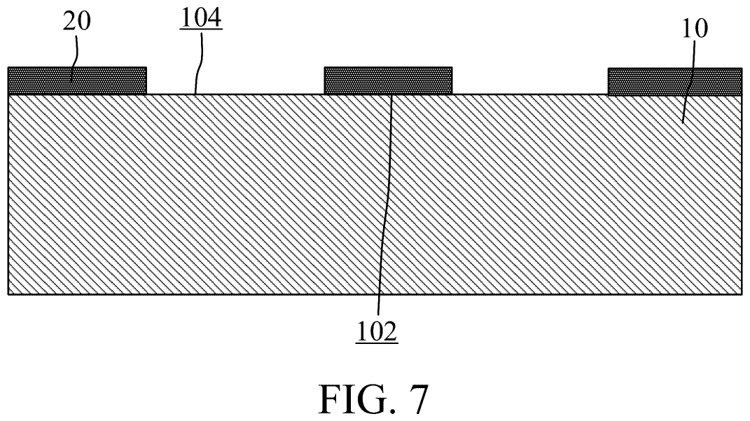

Referring to FIG. 7 through FIG. 10, those figures illustratively show a method, according to the preferred embodiment of the invention, of fabricating the Raman detecting chip 1 as shown in FIGS. 1 and 3 with cross-sectional schematic drawings.

As shown in FIG. 7, firstly, the method according to the preferred embodiment of the invention is to prepare a substrate 10 formed of a semiconductor material such as silicon, germanium, diamond, silicon germanium, silicon carbide, gallium arsenide, indium arsenide, indium phosphide, silicon germanium carbide, gallium arsenide phosphide, gallium indium phosphide, and the like.

Also as shown in FIG. 7, then, the method according to the preferred embodiment of the invention is to partially form a photoresist layer 20 on an upper surface 102 of the substrate 10 by a photolithography process, such that a circular exposed area 104 is formed on the upper surface 102 of the substrate 10.

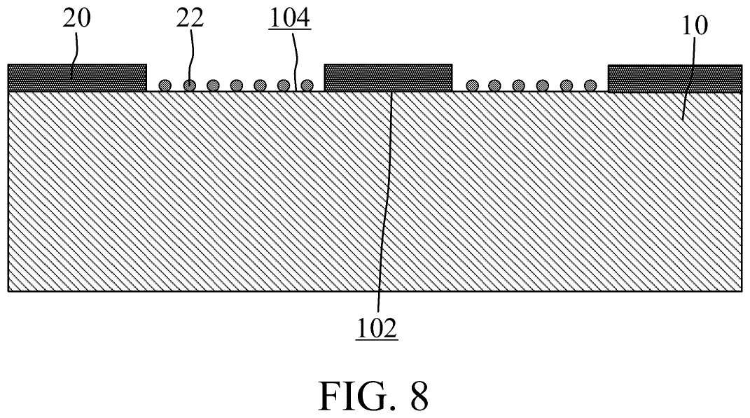

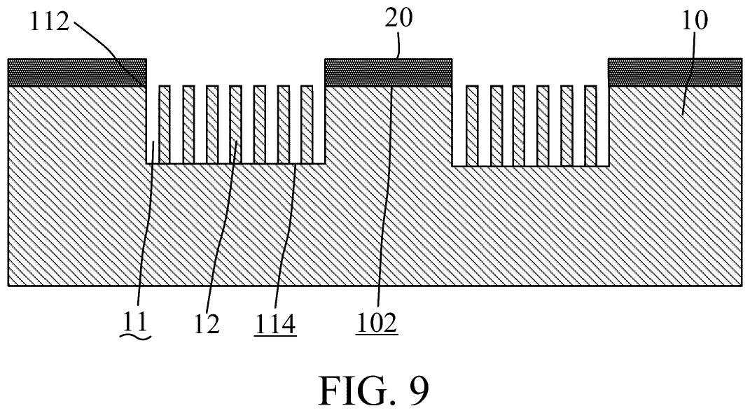

As shown in FIG. 8 and FIG. 9, next, the method according to the preferred embodiment of the invention is by a metal-assisted chemical etching (MACE) process, to etch downwards the substrate 10 at the circular exposed area into a plurality of nanowires 12.

In one example, the substrate 10 formed of silicon is immersed in a solution containing 0.44M silver nitrate (AgNO₃) and 4.6M hydrofluoric acid (HF) for a first process time (about 10 seconds), and then a plurality of silver nanoparticles 22 are formed on the circular exposed area 104 of the upper surface 102 of the substrate 10, as shown in FIG. 8.

Next, the substrate 10 was taken out from the solution containing silver nitrate (AgNO₃) and hydrofluoric acid (HF), and then the substrate 10 is immersed in a solution containing 4.6M hydrofluoric acid (HF) and 0.44M hydrogen peroxide (H₂O₂) and maintained for a second process time (about 4 minutes) to carry out the metal-assisted chemical etching process, and then the area of the circular exposed area 104 not covered by the plurality of silver nanoparticles 22 is etched downwards to form a plurality of nanowire 12, as shown in FIG. 9. The substrate 10 has a recess 11. The recess 11 has a circular opening 112 and a circular bottom surface 114. The plurality of nanowires 12 are formed on the circular bottom surface 114 of the recess 11 and protrude upwards.

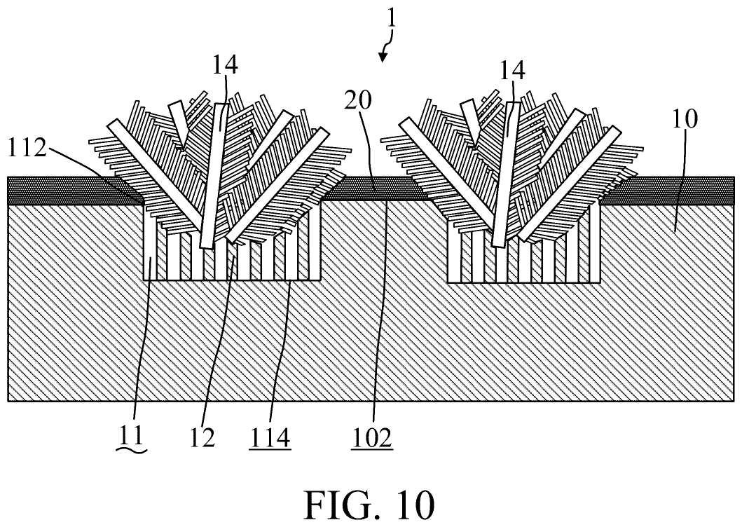

Finally, as shown in FIG. 10, the method according to the preferred embodiment of the invention is by an electroless plating process, to form a plurality of three-dimensional dendritic metal nanostructures 14 on a plurality of tops of the plurality of nanowires 12. The plurality of three-dimensional dendritic metal nanostructures 14 extend beyond the circular opening 112 of the recess 11. The photoresist layer 20 may or may not be removed.

In an example, according to the method of the invention, 500 to 700 mg of silver nitrate, 10 to 14 ml of hydrofluoric acid, and 60 to 80 ml of deionized water are used to prepare solution A. 10 to 20 ml of hydrofluoric acid, 1 to 3 ml of hydrogen peroxide and 80 ml of deionized water are used to prepare solution B. And, 100 to 1000 mg of silver nitrate, 5 to 20 ml of hydrofluoric acid, and 100 to 200 ml of deionized water are used to prepare solution C.

Firstly, the substrate 10 is cleaned and then is immersed in solution A for 10 to 20 seconds. Next, the substrate 10 is washed with deionized water, and then is immersed in solution B for about 3 to 20 minutes. The longer the time in solution B, the longer the formed silicon nanowires.

After the silicon nanowires are formed, the substrate 10 is washed with deionized water, and then is immersed in solution C for about 30 seconds to 5 minutes, where the immersed time of the substrate 10 in solution C affects the thickness of the dendritic silver nanowires. Then, the fabrication of the Raman detecting chip 1 of the invention is finished.

In one embodiment, a solution of an analyte is dropped on the Raman detection chip with a titer (V) to cover the whole of the plurality of three-dimensional dendritic metal nanostructures 14 without overflow. A contact angle (θ) between the solution and the plurality of three-dimensional dendritic metal nanostructures 14 is defined. The contact angle (θ) ranges from 46 degrees to 48 degrees.

In one embodiment, a relationship between a radius (r) of the circular opening 112 of the recess 11 of the substrate 10 of the Raman detecting chip 1 of the invention and the titer (V) is as the following formula:

V=⅔πr³(1−cos θ) (Formula 1),

where the unit of the titer (V) is μL, and the unit of the radius (r) of the circular opening 112 is mm.

In an example, the contact angle (θ) between the solution of the analyte and the plurality of three-dimensional dendritic metal nanostructures 14 is 46.59 degrees. Several radii (r) of the circular opening 112 of the recess 11 of the substrate 10, and the corresponding titers (V) according to Formula 1 are listed in Table 1.

TABLE 1

| radius of circular opening (mm) | 1 | 2 | 5 | 7 | 10 |
|---|---|---|---|---|---|
| titer (μL) | 0.082 | 0.656 | 10.25 | 28.13 | 82 |

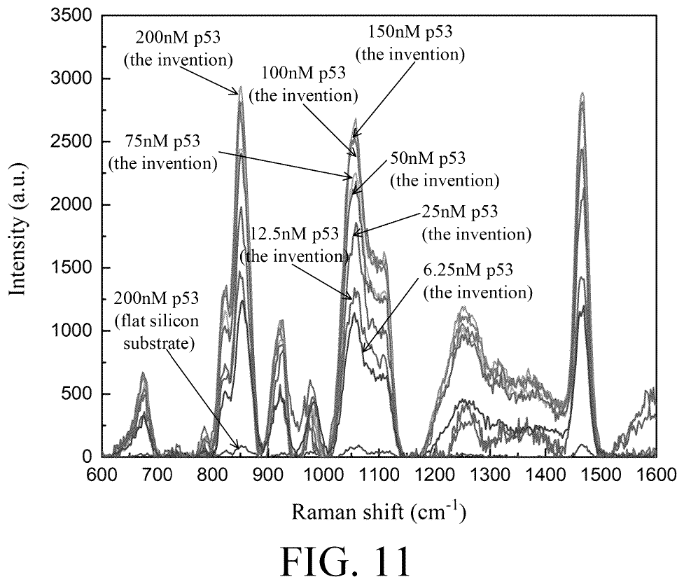

Referring to FIG. 11, the Raman spectrum obtained by using the Raman detecting chip 1 according to the invention to enhance the Raman characteristic peak intensities (analyzed at 850 cm⁻¹ peak) of p53 human tumor suppressor protein at concentrations of 200 nM to 6.25 nM is shown in FIG. 11. As a comparison, the Raman spectrum of p53 human tumor suppressor protein at a concentration of 200 nM detected by using a flat silicon substrate (i.e., unpatterned detecting chip) is also shown in FIG. 11. The Raman characteristic peak intensities of 200 nM and 6.25 nM p53 human tumor suppressor proteins detected by using the Raman detecting chip 1 according to the invention and the flat silicon substrate are listed in Table 2.

The results shown in FIG. 11 and Table 2 confirm that the plurality of three-dimensional dendritic metal nanostructures 14 on the Raman detection chip 1 according to the invention have much higher localized surface plasmon resonance and greatly enhance the Raman characteristic peak intensity.

TABLE 2

| | | intensity | |
|---|---|---|---|
| | | detected by | |
| | intensity | using Raman | |
| | detected by | detecting | signal |
| | using flat | chip of the | amplification |
| | Si substrate | invention | factor |
| 200 nM p53 human | 92 | 2939 | 32 |
| tumor suppressor protein | | | |
| 6.25 nM p53 human | N/A | 1250 | — |
| tumor suppressor protein | | | |

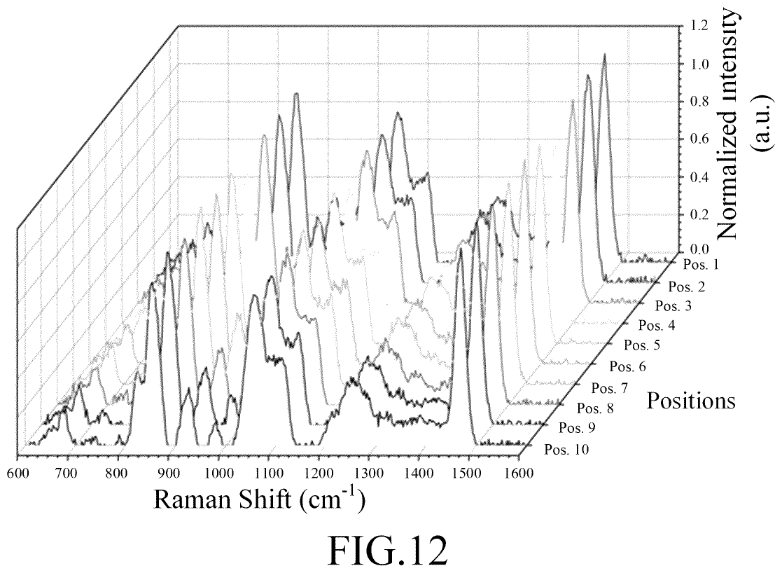

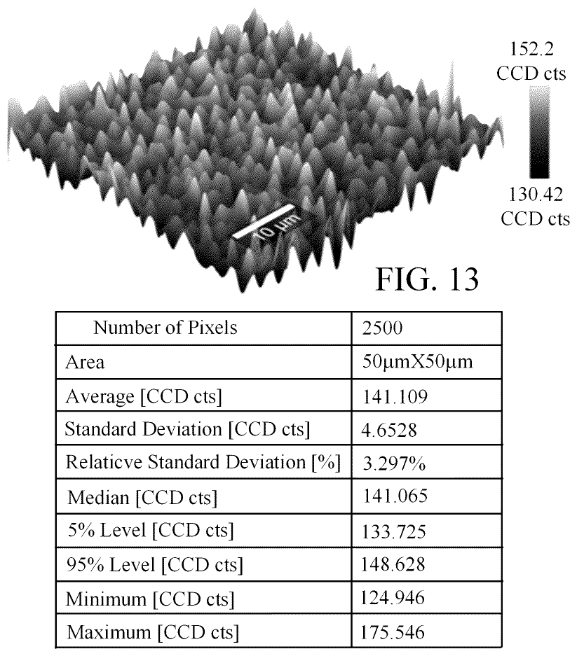

Referring to FIG. 12 and FIG. 13, a Raman spectrum diagram obtained by using the Raman detection chip 1 according to the invention to enhance the detection of p53 tumor suppressor protein droplets with a concentration of 200 nM at 10 random positions in the detection area is shown in FIG. 12. A diagram of Raman characteristic peak intensities (analyzed at 850 cm⁻¹ peak) of 2500 Raman measurements of p53 tumor suppressor protein droplets with a concentration of 200 nM in a randomly selected 50 μm×50 μm of detection area by using the Raman detecting chip according to the invention to enhance the detection is shown in FIG. 13. The radius (r) of the circular opening 112 of the recess 11 of the substrate 10 of the Raman detecting chip 1 according to the invention and the titer (V) of p53 human tumor suppressor protein conform to Formula 1. The results obtained in FIG. 13 are calculated to have a relative standard deviation value of 3.297%. The results shown in FIG. 12 and FIG. 13 confirm that the Raman characteristic peak intensities detected by the Raman detecting chip 1 according to the invention are extremely stable.

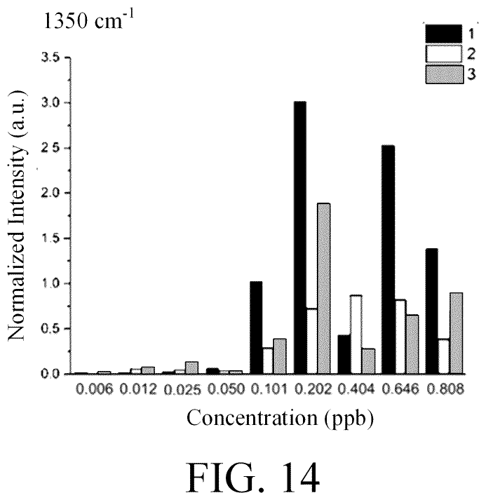

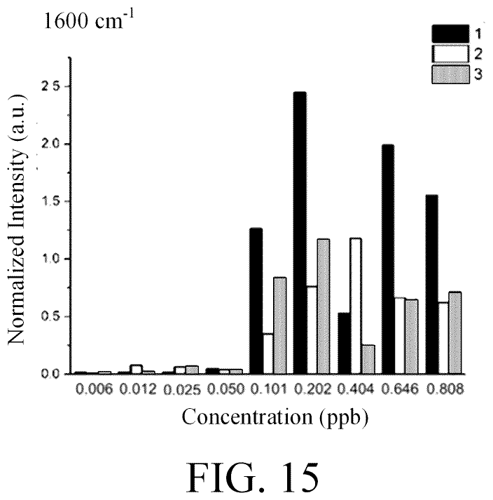

In order to explain in more detail the high gain and stability of the Raman characteristic peak intensity detected by the Raman detecting chip 1 according to the invention, as a comparison, nine flat silicon substrates (that is, unpatterned detecting chips) are used for the detection of troponin I. Each flat silicon substrate is used to detect a centration of troponin I, the intensity values of the 1350 cm⁻¹ and 1600 cm⁻¹ peaks in the Raman spectrum are analyzed, and the analyzed results are shown in FIG. 14 and FIG. 15. The results shown in FIG. 14 and FIG. 15 confirm that the signals of different concentrations of troponin I detected at three positions on each flat silicon substrate vary greatly and are unstable. The mean coefficients of variation (CV) of the intensity values of the 1350 cm⁻¹ peak in FIG. 14 and 1600 cm⁻¹ peak in FIG. 15 are 56% and 50%, respectively.

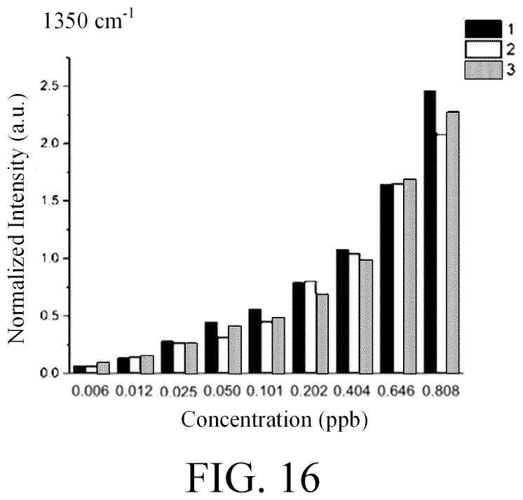

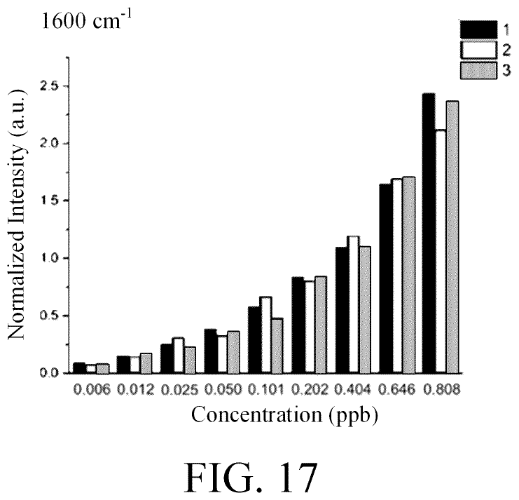

On the contrary, the same detection method adopts nine Raman detecting chips 1 with circular openings 112 of 0.7 cm in diameter according to the invention for detection, the intensity values of the 1350 cm⁻¹ and 1600 cm⁻¹ peaks in the Raman spectrum are analyzed, and the analyzed results are shown in FIG. 16 and FIG. 17. The results shown in FIG. 16 and FIG. 17 confirm that the signals of different concentrations of troponin I detected at three positions on each Raman detecting chip 1 according to the invention are more uniform and repeatable. The mean coefficients of variation (CV) of the intensity values of the 1350 cm⁻¹ peak in FIGS. 16 and 1600 cm⁻¹ peak in FIG. 17 are 9.5% and 8.5%, respectively. It is evident that the Raman signal intensity of the analyte detected in the detection area of the Raman detecting chip 1 according to the invention can be relatively stable.

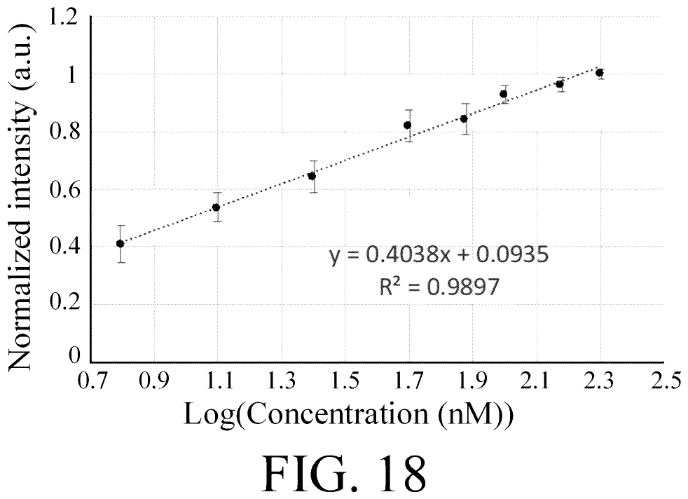

Referring to FIG. 18, a diagram of the relationship between the signal intensity and the concentration detected by using the Raman detecting chip 1 according to the invention to assist in the detection of p53 human tumor suppressor protein at different concentrations (6.25 nM˜200 nM) is shown in FIG. 18. The results shown in FIG. 18 confirm that the signal intensity obtained by using the Raman detection chip 1 according to the invention to detect the analyte has a good linear relationship with the concentration of the analyte. Therefore, the Raman detecting chip 1 according to the invention can be applied to semi-quantitative analysis of analytes.

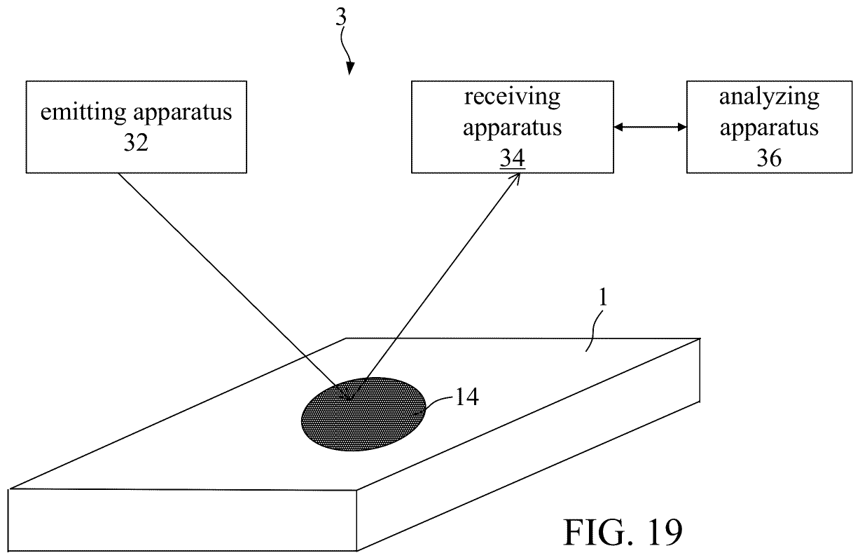

Referring to FIG. 19, FIG. 19 is a schematic diagram showing the architecture of a Raman spectroscopy detecting system 3 according to the preferred embodiment of the invention.

As shown in FIG. 19, the Raman spectroscopy detecting system 3 according to the preferred embodiment of the invention includes a Raman detecting chip 1 according to the invention, an emitting apparatus 32, a receiving apparatus 34 and an analyzing apparatus 36.

A solution of an analyte is dropped on the Raman detecting chip 1 according to the invention with a titer (V) to cover the whole of the plurality of three-dimensional dendritic metal nanostructures 14 without overflow.

The emitting apparatus 32 is for emitting an initial beam onto the plurality of three-dimensional dendritic metal nanostructures 14 of the Raman detecting chip 1 according to the invention. The plurality of three-dimensional dendritic metal nanostructures 14 scatter the initial beam into a scattered beam. The receiving apparatus 34 is for collecting the scattered beam to generate a first Raman characteristic peak intensity. The analyzing apparatus 36 therein stores a relationship between a second Raman characteristic peak intensity and a first concentration relative to the analyte. The analyzing apparatus 36 is electrically connected to the receiving apparatus 34, and is for determining a second concentration of the analyte in accordance with the first Raman characteristic peak intensity and the relationship.

When using the Raman detecting chip 1 according to the invention and the Raman spectroscopy detecting system 3 according to the invention for Raman detection of the analyte, the qualitative analysis of the analyte can be performed by using the specific fingerprint spectrum of the analyte itself, and the semi-quantitative analysis of the analyte can also be performed with the Raman characteristic peak intensities at the same time. In this way, the invention can achieve high-sensitivity detection of real complex samples. In addition, in this way, the detection and analysis of various analytes can be achieved with only one sampling, which greatly saves the demand for samples.

With the detailed description of the above preferred embodiments, it is believed that the plurality of three-dimensional dendritic metal nanostructures on the Raman detecting chip according to the invention have much higher localized surface plasmon resonance. The solution of the analyte does not generate the coffee ring effect on the Raman detection chip according to the invention. The signal intensities of the Raman spectrum characteristic peaks obtained at different detected positions are very similar. The method of fabricating the Raman detecting chip according to the invention has short process time and low process cost. The Raman spectroscopy detecting system using the Raman detecting chip according to the invention has with semi-quantitative detection capability.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A Raman detecting chip, comprising:
a substrate, formed of a semiconductor material, the substrate having an upper surface and a recess formed on the upper surface, the recess having a circular opening and a circular bottom surface;
a plurality of nanowires, formed of the semiconductor material, the plurality of nanowires being formed on the circular bottom surface and protruding upwards; and
a plurality of three-dimensional dendritic metal nanostructures, being formed on a plurality of tops of the plurality of nanowires and extending beyond the circular opening.

2. The Raman detecting chip of claim 1, wherein a solution of an analyte is dropped on the Raman detection chip with a titer (V) to cover the whole of the plurality of three-dimensional dendritic metal nanostructures without overflow, a contact angle (θ) between the solution and the plurality of three-dimensional dendritic metal nanostructures is defined, and a relationship between a radius (r) of the circular opening and the titer (V) is as the following formula:
V=⅔πr³(1−cos θ),
wherein the unit of the titer (V) is μL, and the unit of the radius (r) of the circular opening is mm.

3. The Raman detecting chip of claim 2, wherein a cross-sectional width of each three-dimensional dendritic metal nanostructure ranges from 40 μm to 250 μm.

4. The Raman detecting chip of claim 3, wherein a height of each nanowire ranges from 0.5 μm to 15 μm.

5. The Raman detecting chip of claim 4, wherein the plurality of three-dimensional dendritic metal nanostructures are formed of one selected from the group consisting of silver (Ag), gold (Au), aluminum (Al), copper (Cu), tin (Sn), titanium (Ti), barium (Ba), platinum (Pt), cobalt (Co) and a mixture therebetween.

6. A method of fabricating a Raman detecting chip, comprising the steps of:
preparing a substrate formed of a semiconductor material;
partially forming a photoresist layer on an upper surface of the substrate such that a circular exposed area is formed on the upper surface of the substrate;
by a metal-assisted chemical etching process, etching downwards the substrate at the circular exposed area into a plurality of nanowires, wherein the substrate has a recess, the recess has a circular opening and a circular bottom surface, the plurality of nanowires are formed on the circular bottom surface and protrude upwards; and
by an electroless plating process, forming a plurality of three-dimensional dendritic metal nanostructures on a plurality of tops of the plurality of nanowires, wherein the plurality of three-dimensional dendritic metal nanostructures extend beyond the circular opening.

7. The method of claim 6, wherein a solution of an analyte is dropped on the Raman detection chip with a titer (V) to cover the whole of the plurality of three-dimensional dendritic metal nanostructures without overflow, a contact angle (θ) between the solution and the plurality of three-dimensional dendritic metal nanostructures is defined, and a relationship between a radius (r) of the circular opening and the titer (V) is as the following formula:
V=⅔πr³(1−cos θ),
wherein the unit of the titer (V) is μL, and the unit of the radius (r) of the circular opening is mm.

8. The method of claim 7, wherein a cross-sectional width of each three-dimensional dendritic metal nanostructure ranges from 40 μm to 250 μm.

9. The method of claim 8, wherein a height of each nanowire ranges from 0.5 μm to 15 μm.

10. A Raman spectroscopy detecting system, comprising:
a Raman detecting chip, comprising:
a substrate, formed of a semiconductor material, the substrate having an upper surface and a recess formed on the upper surface, the recess having a circular opening and a circular bottom surface;
a plurality of nanowires, formed of the semiconductor material, the plurality of nanowires being formed on the circular bottom surface and protruding upwards; and
a plurality of three-dimensional dendritic metal nanostructures, being formed on a plurality of tops of the plurality of nanowires and extending beyond the circular opening, wherein a solution of an analyte is dropped on the Raman detection chip with a titer (V) to cover the whole of the plurality of three-dimensional dendritic metal nanostructures without overflow, a contact angle (θ) between the solution and the plurality of three-dimensional dendritic metal nanostructures is defined, and a relationship between a radius (r) of the circular opening and the titer (V) is as the following formula:
V=⅔πr³(1−cos θ),
wherein the unit of the titer (V) is μL, and the unit of the radius (r) of the circular opening is mm;
an emitting apparatus, for emitting an initial beam onto the plurality of three-dimensional dendritic metal nanostructures, wherein the plurality of three-dimensional dendritic metal nanostructures scatter the initial beam into a scattered beam;
a receiving apparatus, for collecting the scattered beam to generate a first Raman characteristic peak intensity; and
an analyzing apparatus, therein storing a relationship between a second Raman characteristic peak intensity and a first concentration relative to the analyte, the analyzing apparatus being electrically connected to the receiving apparatus and being for determining a second concentration of the analyte in accordance with the first Raman characteristic peak intensity and the relationship.
